(19) United States
(12) Patent Application Publication
(10) Pub. No.: US 2009/0024481 A1
(43) Pub. Date: Jan. 22, 2009

(54) Method and system for generating a real time offer or a deferred offer

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/217,824

(22) Filed: Jul. 9, 2008

Related U.S. Application Data
(63) Continuation-in-part of application No. 12/151,038, filed on May 2, 2008.
Application No. 12/151,038 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00

(52) U.S. Cl. 705/14; 705/26

(57) ABSTRACT

A system for generating a real time offer or a deferred offer, including: an interface element, for at least one specially programmed general-purpose computer, arranged to receive an order from an end user device (EUD), the order including an first or service available from a business entity; and an offer element, in a processor for the computer, arranged to: generate, prior to fulfillment of the order by the business entity and using at least one of a first set of rules or a first artificial intelligence program stored in a memory unit for the computer, a first offer fulfillable as part of the order; and generate, prior to fulfillment of the order by the business entity and using the processor and at least one of a second set of rules or a second artificial intelligence program stored in the memory unit, a second offer fulfillable after fulfillment of the order by the business entity; and transmit, using the interface element, the first and second offers to the EUD.

### CROSS-REFERENCE TO RELATED APPLICATIONS

This is a continuation-in-part patent application under 35 USC 120 of U.S. patent application Ser. No. 12/151,038, filed May 2, 2008 and entitled: “Method and Apparatus For Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system to generate and transmit follow-up offers to a WCD, from which an order has been received, using one or both of at least one rule or an artificial intelligence program.

### BACKGROUND OF THE INVENTION

It is known for a business location to receive an order. Unfortunately, it is not known how to respond to the order with an additional offer that is maximally acceptable to a WCD or an end user of a WCD or also maximizes goals of the retail location.

Thus, there is a long-felt need to provide a system and a method to intelligently and automatically generate a follow-up offer to a received order in terms of acceptability to the end user and alignment with criteria for a business location accepting the order.

### SUMMARY OF THE INVENTION

The invention broadly comprises a system for generating a real time offer or a deferred offer, including: an interface element, for at least one specially programmed general-purpose computer, arranged to receive an order from an end user device (EUD), the order including a first item or service available from a first business entity; and an offer element, in a processor for the at least one specially programmed general-purpose computer, arranged to: generate, prior to fulfillment of the order by the first business entity and using at least one of a first set of rules or a first artificial intelligence program stored in a memory unit for the at least one specially programmed general-purpose computer, a first offer fulfillable as part of the order; and generate, prior to fulfillment of the order by the first business entity and using the processor and at least one of a second set of rules or a second artificial intelligence program stored in the memory unit, a second offer fulfillable after fulfillment of the order by the first business entity; and transmit, using the interface element, the first and second offers to the EUD.

In one embodiment, the first and second sets of rules are the same or the first and second artificial intelligence programs are the same. In another embodiment, the first and second offers are the same. In a further embodiment, the first and second offers include second and third items or services, respectively and the second and third items or services are the same or the second and third items or services are different. In yet another embodiment, the first and second offers include first and second incentives, respectively and the first and second incentives are the same or the first and second incentives are different.

In one embodiment, the offer element is arranged to determine, using at least one of a third set of rules or a third artificial intelligence program stored in the memory unit, whether to transmit the second offer before or after receipt of payment for the second offer. In another embodiment, the EUD is a wireless communications device (WCD) storing at least one third rule in a memory element for the WCD and arranged to execute, using a processor in the WCD, the first or second offer according to the at least one third rule. In a further embodiment the interface element is arranged to receive at least one third rule from a WCD, or from a general-purpose computer associated with a second business entity and the offer element is arranged to: store the at least one third rule in the memory element; and modify the first or second offer using the processor and the at least one third rule. In yet another embodiment, the first and second business entities are the same.

The invention also broadly comprises a method for generating a real time offer or a deferred offer.

It is a general object of the present invention to provide a system and a method to generate real time or deferred offers.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD).

FIG. 3 is a block diagram for a present invention system for generating a real time offer or a deferred offer;

FIG. 4 is a flow chart illustrating a present invention computer-based method for generating a real time offer and/or a deferred offer; and,

FIG. 5 is a flow chart illustrating a present invention computer-based method for generating a real time offer and/or a deferred offer.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

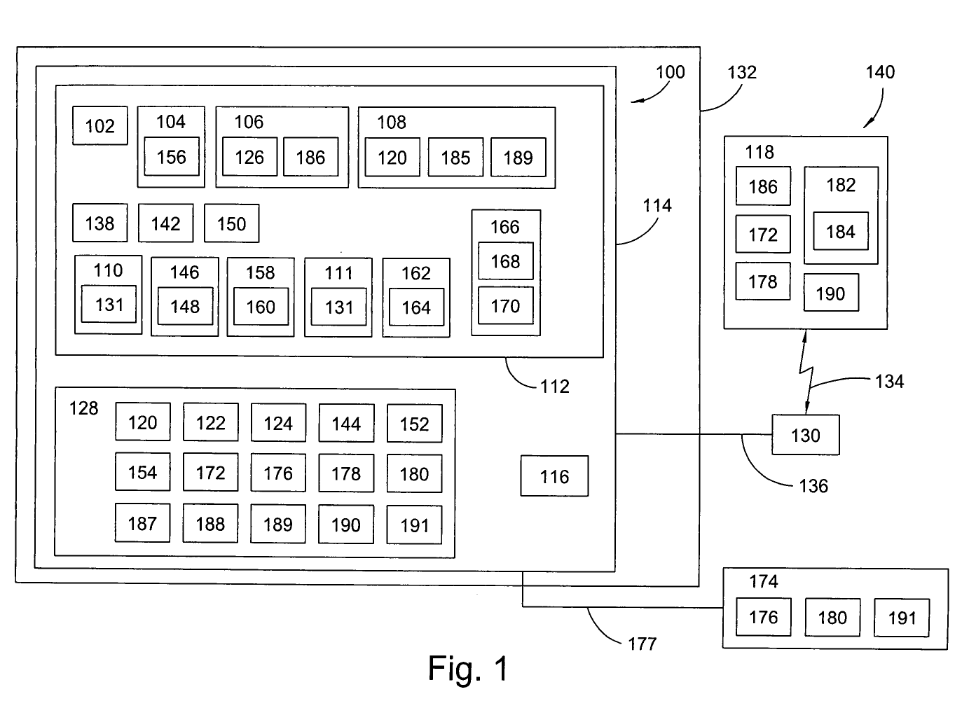

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

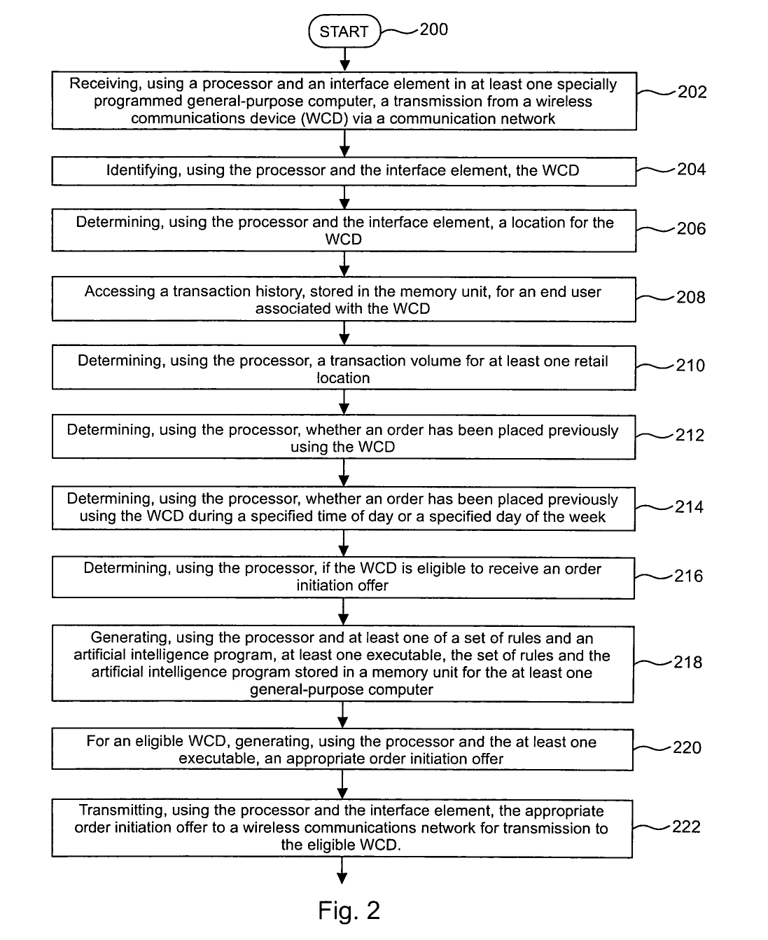

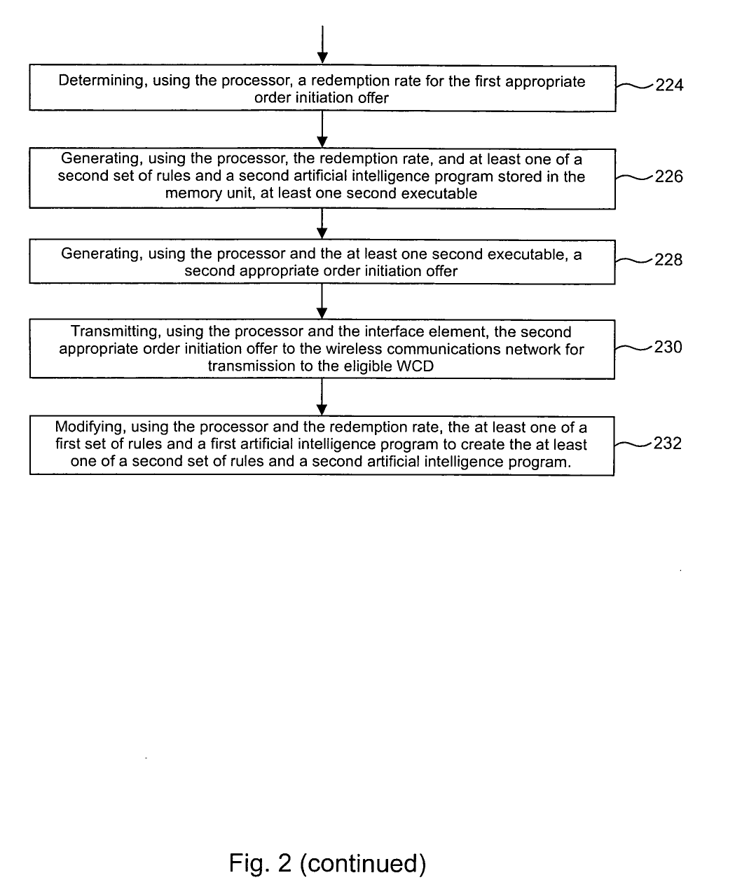

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

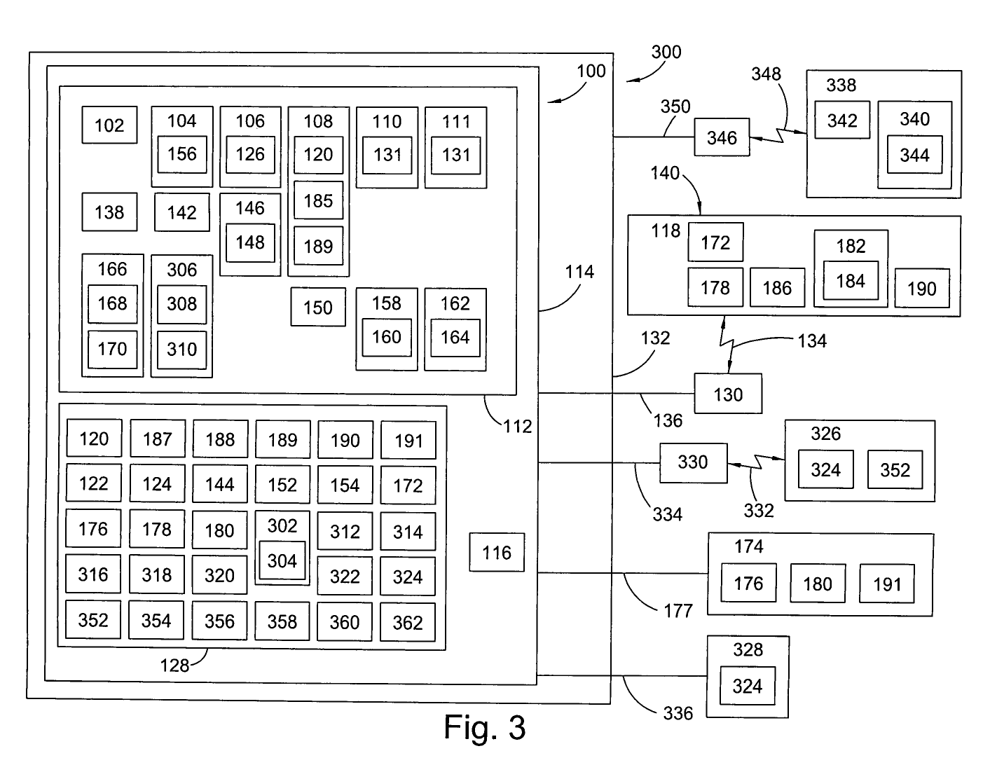

FIG. 3 is a block diagram for present invention system 300 for generating a real time offer or a deferred offer. The following should be viewed in light of FIGS. 1 through 3. System 300 is based on system 100 described in FIG. 1. Interface element 116 receives order 302 from an end user device (EUD). The EUD can be any EUD known in the art. In one embodiment, the EUD is WCD 118. In another embodiment (not shown), the EUD is one of a self-serve kiosk, a point of sale terminal, or a card authorization terminal. In the discussion that follows, the EUD is WCD 118; however, it should be understood that the discussion is applicable to any EUD known in the art.

The interface device stores the order in memory 128. In one embodiment, order 302 is the same as order 131. Order 302 includes at least one item or service 304 available from a business entity associated with location 132 (hereafter referred to as the first business entity). The following discussion is generally directed to an item 304; however, it should be understood that the discussion also is applicable to a service 304. System 300 also includes offer element 306, which generates offers 308 or 310 prior to completion, or fulfillment, of order 302 by the first business entity and transmits the offer(s) to the EUD. That is, offers 308 or 310 are transmitted to the EUD as part of the process of accepting and fulfilling order 302. For example, if location 132 is a restaurant, offers 308 or 310 are transmitted to the EUD before a food order is completed and made available to the customer placing order 302. In one embodiment, both offers are generated and transmitted. In another embodiment, only one or the other of the offers is generated and transmitted.

The offer element generates offer 308 using at least one of a set of rules 312 or artificial intelligence program 314 stored in memory unit 128. In general, the use of an AI program in system 300 includes the generation of one or more executables that are used to generate or modify an offer or constitute the offer. Offer 308 includes at least one item or service available from the first business entity and is fulfillable as part of the order. That is, the item or service included in offer 308 can be added to order 302. For example, if the first business entity is a restaurant and order 302 is for food items, a food item in offer 308 can be added to the food items in order 302 and the respective food items in order 302 and offer 308 can be presented together.

The offer element generates offer 310 using at least one of a set of rules 316 or artificial intelligence program 318 stored in memory unit 128. Offer 310 includes at least one item or service available from the first business entity and is fulfillable after fulfillment of the order by the first business entity. That is, the item or service included in offer 310 is not be added to order 302, but is fulfillable as a future order (not shown). In one embodiment, offer 310 is a printed or electronic coupon that is redeemable (depending on payment arrangements described infra) at a later date. For example, if the first business entity is a restaurant a food item in offer 310 is not added to order 302, but instead is in the form of a coupon for later redemption. In another embodiment, one or both of offers 308 and 310 include any incentive known in the art.

In a first embodiment, rules 312 and 316 are the same or artificial intelligence programs 314 and 318 are the same. In a second embodiment, offers 308 and 310 are the same. In a third embodiment, offers 308 and 310 include respective items or services that are the same. In a fourth embodiment, offers 308 and 310 include respective items or services that are different. In a fifth embodiment, offers 308 and 310 include respective incentives that are the same. In a sixth embodiment, offers 308 and 310 include respective incentives that are different.

In one embodiment, offer 310 is not made available to an end user of the EUD until payment is received for the offer. For example, information regarding the offer, such as items, services, or incentives in the offer, is transmitted to the EUD, along with the price for obtaining the offer, for example, receiving a redeemable coupon for the offer. Then, upon receipt of payment, using any means known in the art, for offer 310, the offer is validated for the EUD, for example, by transmitting a redeemable coupon, such as an electronic coupon, to the EUD.

In another embodiment, offer 310 is made available to an end user of the EUD before payment is received for the offer. For example, a non-redeemable coupon for items, services, or incentives included in the offer is transmitted to the EUD. Then, in order to redeem the coupon, payment must be provided, using any means known in the art, for offer 310. Any redemption/payment arrangement, such as printed or electronic coupons, known in the art can be used.

In a further embodiment, the offer element determines, using at least one of set of rules 320 or artificial intelligence program 322 stored in the memory unit, whether to transmit offer 310 before or after receipt of payment for the second offer. For example, the offer element determines whether to present offer 310 as a coupon that must be paid for in advance or as a coupon that can be paid for (and made redeemable) at a later date. In a still further embodiment, two or more of rules 312, 316, or 320 are the same or two or more of programs 314, 318, or 322 are the same.

In one embodiment, the offer element determines, using at least one of set of rules 356 or artificial intelligence program 358 stored in the memory unit, whether to generate and transmit both offers 308 and 310 or whether to generate and transmit only one of offers 308 or 310. In another embodiment, if only one of the offers is generated and transmitted, the offer element determines, using at least one of set of rules 360 or artificial intelligence program 362 stored in the memory unit, which of the offers to generate and transmit. In a further embodiment, two or more of rules 312, 316, 320, 356, or 360 are the same or two or more of programs 314, 318, 322, 358, or 362 are the same.

In one embodiment, the interface element is arranged to receive, at least one rule 324 from WCD 326, or from general-purpose computer 328 associated with a business entity and stores rule 324 in memory element 128. The business entity associated with computer 328 can be related to or the same as the business entity for location 132 or can be a separate business entity. In another embodiment (not shown), multiple computers 328 are included and respective computers among the multiple computers can be associated with the same or different business entities. Offer element 306 modifies offers 308 or 310 using rule 324 and transmits, using the interface element, modified offers 308 or 310 to the EUD. WCD 326 is connected to wireless communications network 330 with radio frequency connection 332. Network 330 is connected to computer 114 with hardwire connection 334. Connection 336 between computers 114 and 328 can be any type known in the art. The discussion, in the description of FIG. 1, of WCD 118 and network 130 is applicable to WCD 326 and network 330, respectively. The discussion, in the description of FIG. 1, of WCD 118 and rules 172 and 178 is applicable to WCD 326 and rule 324, respectively.

In one embodiment, WCD 338 includes memory element 340 and processor 342. WCD 338 stores at least one rule 344 in the memory element and processor 342 executes offer 308 or offer 310 according to rule 344. In another embodiment, processor 342 executes modified offer 308 or modified offer 310 according to rule 344. WCD 338 is connected to wireless communications network 346 with radio frequency connection 348. Network 346 is connected to computer 114 with hardwire connection 350. The discussion, in the description of FIG. 1, of WCD 118 and network 130 is applicable to WCD 338 and network 346, respectively. The discussion, in the description of FIG. 1, of WCD 118 and rule 184 is applicable to WCD 338 and rule 344, respectively.

In a further embodiment, if an acceptance of offer 308 or offer 310 is not received by the interface element from the EUD upon completion of order 302, one or both of offer 308 or offer 310 is retransmitted to the EUD. In yet another embodiment, the offer element determines a time frame for retransmission or whether to retransmit one or both of the offers using at least one of a set of rules 352 or artificial intelligence program 354 stored in memory unit 128. In yet a further embodiment, two or more of rules 312, 316, 320, 352, 356, or 360 are the same or two or more of programs 314, 318, 322, 354, 358, or 362 are the same.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

In yet another embodiment, third party offers can be made by system 300. For example, an incentive in offers 308 or 310 can be an item or service provided by a third party (for example, a party or entity different than the first business entity). If the offer is accepted, system 300 transmits billing and delivery information to the third party for fulfillment. In one embodiment, the third party pays a finders fee, for example, to the first business entity and charges the fulfillment to a WCD.

It should be understood that system 300 can be integral with a computer operating system for a business location, for example, location 132 or with a business entity operating the business location. It also should be understood that system 300 can be wholly or partly separate from the computer operating system for a retail location, for example, location 132 or with a business entity operating the retail location.

It should be understood that the examples above regarding executables or other operations by artificial intelligence programs are non-limiting, are meant to provide only a broad overview, and do not address the number, complexity, structure, or interrelationships of the operations included in the actual generation of the executables or functioning of the artificial intelligence programs. It also should be understood that although individual rule sets and AI programs are discussed, the individual rule sets and AI programs can be combined into rules sets or AI programs including more than one of the individual rule sets or AI programs, respectively.

In a first embodiment, a present invention system or method presents and offer during transactions for items or services that can be added to a purchase total. In one embodiment, the offer, for example, offer 308 enables an end user to add an item or service to an order immediately. In another embodiment, the offer, for example, offer 310, enables the end user to accept a coupon for an item or service that can be redeemed at a later date. In a further embodiment, if the customer chooses to accept the item immediately, the item can added to the order, for example, order 302, the purchase total is adjusted, and, if appropriate, the item is incorporated into the fulfillment of order 302. In yet another embodiment, if the customer chooses to accept the coupon, the order total is adjusted and a coupon is printed.

In a first embodiment, the coupons that are printed are prepaid and can include total transaction information. When the coupons are redeemed, the coupons can instantly initiate a new transaction by adding the prepaid item or service to the order. In a second embodiment, the coupons that are printed are not prepaid and can include total transaction information. When the coupons are presented for redemption, the coupons can instantly initiate a new transaction starting with the item or service in the coupon. In a third embodiment, the offers interrupt the transaction for order 302 or are available as a sub menu that the end user can select to see available offers.

In one embodiment, the nature or specifics of offer 308 or offer 310 are not provided when the offer is transmitted to the EUD. That is, the offers are “mystery” offers. In another embodiment, the recipient of offer 308 or offer 310 is required to log on to a website (not shown) associated with system 300 and enter a code provided with offer 308 or offer 310 to see what items or services can be redeemed for offer 308 or offer 310.

A coupon associated with offer 308 or offer 310 can be paper or electronic. An electronic coupon can be transmitted to the EUD, using any means known in the art, including, but not limited to, transmitting or emailing to a WCD. In one embodiment, when the device is identified at the store again, the electronic coupon can instantly start the order with the specified item. In one embodiment, detection and use of a location for a EUD is as described in U.S. patent application Ser. No. 12/151,038, filed May 2, 2008 and entitled: “Method and Apparatus For Generating and Transmitting an Order Initiation Offer to a Wireless Communications Device.” The coupon does not actually need to be transmitted to the device—the POS system can store the cell phone id and the next time the cell phone id is identified, it can retrieve the coupon that has been stored in the system.

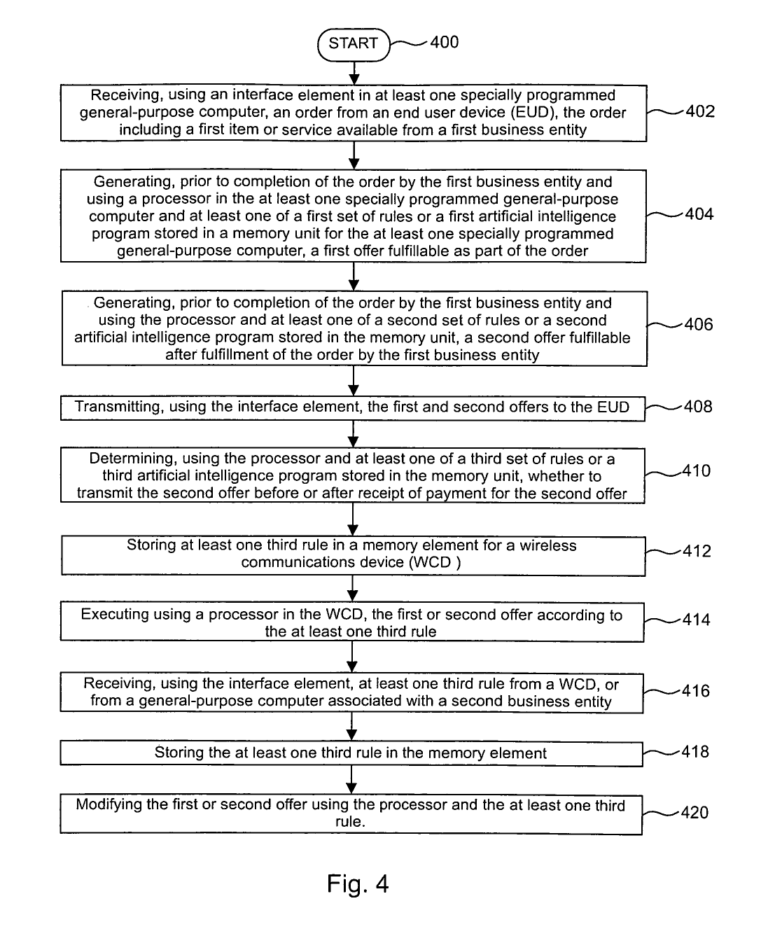

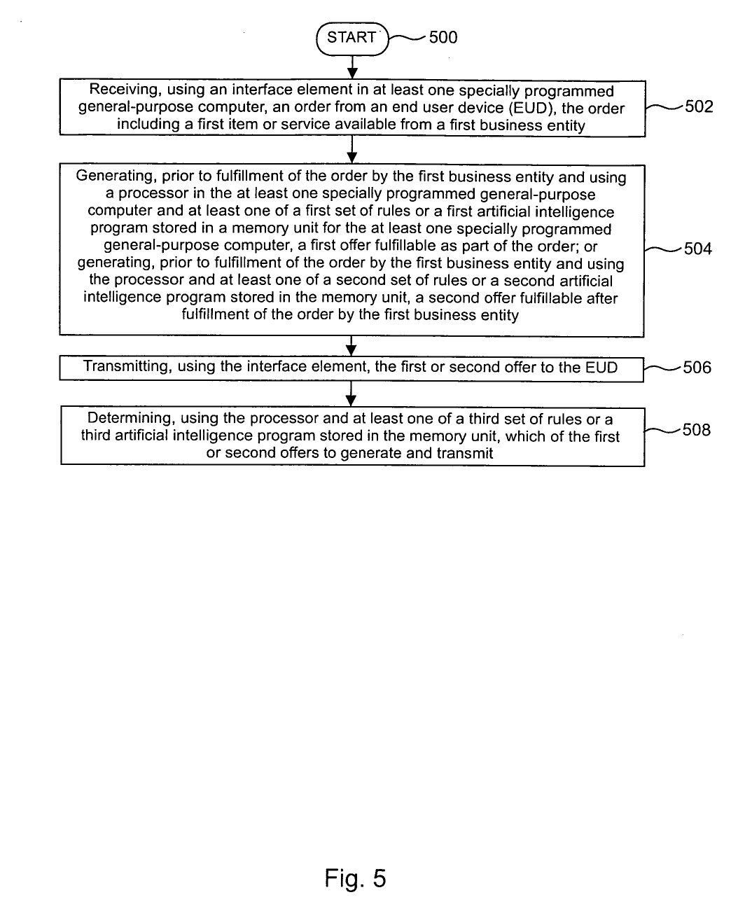

FIG. 4 is a flow chart illustrating a present invention computer-based method for generating a real time offer and/or a deferred offer. Although the method in FIG. 4 (and FIG. 5, infra) is depicted as a sequence of numbered steps for clarity, no order should be inferred from the numbering unless explicitly stated. The method starts at Step 400. Step 402 receives, using an interface element in at least one specially programmed general-purpose computer, an order from an end user device (EUD), the order including a first item or service available from a first business entity. Step 404 generates, prior to completion of the order by the first business entity and using a processor in the at least one specially programmed general-purpose computer and at least one of a first set of rules or a first artificial intelligence program stored in a memory unit for the at least one specially programmed general-purpose computer, a first offer fulfillable as part of the order. Step 406 generates, prior to completion of the order by the first business entity and using the processor and at least one of a second set of rules or a second artificial intelligence program stored in the memory unit, a second offer fulfillable after fulfillment of the order by the first business entity. Step 408 transmits, using the interface element, the first and second offers to the EUD.

In a first embodiment, the first and second sets of rules are the same or the first and second artificial intelligence programs are the same. In a second embodiment, the first and second offers are the same. In a third embodiment, the first and second offers include second and third items or services, respectively and the second and third items or services are the same or the second and third items or services are different. In a fourth embodiment, the first and second offers include first and second incentives, respectively and the first and second incentives are the same or the first and second incentives are different.

In one embodiment, step 410 determines, using the processor and at least one of a third set of rules or a third artificial intelligence program stored in the memory unit, whether to transmit the second offer before or after receipt of payment for the second offer. In another embodiment, step 412 stores at least one third rule in a memory element for the WCD and step 414 executes, using a processor in the WCD, the first or second offer according to the at least one third rule. In a further embodiment, step 416 receives, using the interface element, at least one third rule from a WCD, or from a general-purpose computer associated with a second business entity; step 418 stores the at least one third rule in the memory element; and step 420 modifies the first or second offer using the processor and the at least one third rule. In yet another embodiment, the first and second business entities are the same.

FIG. 5 is a flow chart illustrating a present invention computer-based method for generating a real time offer or a deferred offer. The method starts at step 500. Step 502 receives, using an interface element in at least one specially programmed general-purpose computer, an order from an end user device (EUD), the order including a first item or service available from a first business entity. Step 504 generates, prior to fulfillment of the order by the first business entity and using a processor in the at least one specially programmed general-purpose computer and at least one of a first set of rules or a first artificial intelligence program stored in a memory unit for the at least one specially programmed general-purpose computer, a first offer fulfillable as part of the order; or generates, prior to fulfillment of the order by the first business entity and using the processor and at least one of a second set of rules or a second artificial intelligence program stored in the memory unit, a second offer fulfillable after fulfillment of the order by the first business entity. Step 506 transmits, using the interface element, the first or second offer to the EUD. In one embodiment, step 508 determines, using the processor and at least one of a third set of rules or a third artificial intelligence program stored in the memory unit, whether to generate and transmit the first offer or the second offer. In another embodiment, one or more of the first, second, or third sets of rules are the same or one or more of the first, second, or third artificial intelligence programs are the same.

The following should be viewed in light of FIGS. 1 through 5. The following is a non-limiting example of a present invention system or method. A fast serve restaurant is used to illustrate operation of a present invention system or method; however, it should be understood that a present invention system or method is not limited to use with a fast serve restaurant and that operation of a present invention system or method with any business entity providing an item or service to a customer is included within the spirit and scope of the claimed invention. The customer is an end user of WCD 118. Order 302 is placed by WCD 118 and restaurant 132 places the order in the appropriate queue. When the order is ready for the customer, for example, the item or items in the order are cooked or assembled, offers 308 and 310 are generated by the offer element and sent to WCD 118 along with a notice to the EUD that the order is complete. The discussion, in the description of FIG. 1, regarding the generation of offer 120 by offer element 108 is applicable to the generation of offers 308 and 310 by offer element 306. For example, rules, artificial intelligence, a history of an end user for WCD 118, or parameters associated with operation of the restaurant can be used to generate the offer.

If offer 308 is accepted, item(s) included in the offer and selected from the offer are added to order 302, and, if appropriate, added to the queue for preparation or assembly. When order 302 is ready, a message is sent to WCD 118. Order 302 can be paid for by any means known in the art, for example, billed to an electronic payment system associated with WCD 118, or can be paid using conventional methods in the restaurant. The end user is prompted to enter a payment type and the transaction is flagged as “paid with device” or “requires payment” at the POS unit (not shown) of the restaurant handling order 302.

If offer 310 is accepted, a coupon for items included in the offer and selected from the offer is generated and transmitted to or otherwise made available to an end user of the WCD. The coupon can be prepaid, for example, as part of the payment of order 302 or can be paid for at the time of redemption. The coupon can be paid for by any means known in the art, for example, billed to an electronic payment system associated with WCD 118, or can be paid using conventional methods in the restaurant. The end user is prompted to enter a payment type and the transaction is flagged as “paid with device” or “requires payment” at the POS unit (not shown) of the restaurant handling order 302.

In system 300, computer 114 is configured to generate and transmit an offer, for example offer 308 or offer 310, in response to an order using rules or AI programs. In one embodiment, a present invention system, for example, system 300, adds additional layers of distributed control and input or distributed control of the implementation of executables from the central system (computer 114). For example, computer 114 generates and optimizes offers, for example offer 308 or offer 310, in response to an order. However, this operation is further constrained by rules, for example, rule 324, provided an outside computer or WCD, for example, computer 328 or WCD 326. The rules specified by a business entity associated with the outside computer, for example, computer 328, or specified by the WCD, for example, WCD 326, can be self generated or end user implemented. Rules or filters can all be stored at the central system, or can be distributed across the various pieces of hardware in system 300.

In another embodiment, computer 114 tracks search, purchase, and travel behavior of a WCD, such as WCD 118. In a further embodiment, retailers may import or otherwise access transaction history of WCD end users that are mapped to a specific WCD or group of WCDs.

Computer 114 can use data collected from a WCD as well as the data provided by one or more business entities about the WCD to generate offers to the WCD. System 300 also can serve as a point of sales system for the business entity associated with location 132, for example, enabling the entity to store transaction information about WCDs making purchases with the entity. Computer 114 can use the transaction history data to refine offers made to WCDs. In still another embodiment, computer 114 operates as a phone service provider and web search engine for the WCDs, enabling the computer to store a call log of the WCDs which can be used to refine offers made to WCDs.

In one embodiment, if offer 308 or 310 is rejected, or otherwise not acted upon, an additional offer can be made and transmitted or the original offer can be modified and re-transmitted as disclosed by commonly-owned U.S. patent application titled: “SYSTEM AND METHOD FOR PROVIDING INCENTIVES TO AN END USER FOR REFERRING ANOTHER END USER” inventors Otto et al., filed concurrently.

The present invention can use tables, rules, genetic algorithms or any combination of the forgoing.

The following is a non-limiting example of a possible sequence for a present invention method or system. A first general aspect is generating an offer: receive customer ID (optional); receive order; generate offer; if offer accepted, was offer for real time; if offer was for real time, add offer item(s) to purchase total and add item to order for assembly and fulfillment; if offer was not for real time, generate and output coupon; add coupon purchase to order total; receive payment; and process transaction. A second general aspect is with respect to a storing an electronic coupon: receive acceptance of coupon offer; receive end user ID; and store coupon offer with end user ID.

The following is a non-limiting example of a possible sequence for a present invention method or system.
1. Customer accepts a “later offer”
2. Printing coupon with:
   a. Accepted offer item
   b. Bar Code Number with a GUID—Globally Unique ID—single use number that is linked to a database that contains the: Date and time, transaction and store number, item number, third party or vendor item number, menu item price, sales (discounted) price, sales tax (estimate), store zip code, state code.
   c. Store name and address (in customer readable format)
   d. Expiration date (if any), which should be user definable
3. Using the “integrated” method, coupons may be treated as “deferred sales.” Therefore, when the customer accepts a coupon offer item, the system might return a “voucher” that is good for the future delivery of a specific menu item. The voucher, which displays the menu item selected and the total amount of the discount off of menu item price.
4. Customer returns to store or location with the voucher (or coupon) to redeem it
5. Cashier scans the voucher or coupon
6. The system attempts to validate the voucher/coupon number by:
   a. If the system is attached to the Internet, it will look up the number on the remote database (whether located at the retail operator's or some other facilities, e.g., a co-lo or at the franchisee's data center), or
   b. If the Internet is down or if the location operator, e.g., a franchisee has decided upon local validation only, the system could check the number on its local database only or using a validation algorithm, e.g., check sum or other method(s). This database is created even if the Internet option is selected so that there is always a local file. If the Internet option were implemented, the system would also distribute other store's negative file to stores within its local geographic territory (e.g., using zip or state codes (depending upon estimated file sizes) so that in an off-line setting, customers could still redeem coupons at store locations other than the store where the voucher was originally purchased). This option may require an added level of programming sophistication, i.e., when the Internet is back online, the system could synchronize the various stores' databases, bringing all locations up to date.
7. If the voucher number is found, the system could flag the voucher as “redeemed” in the file, along with the date, time, store number, total check amount, other items ordered, cashier id or name, etc.
8. If the voucher is valid, the offer item may be automatically added to the order via an enhanced POS or other interface. The improved interface would enable the start of an order and add an item or items to the order, which could then be processed by the POS system for production, accounting, tax and other purposes. Once the item is added to the order, the remaining order processing occurs as usual or the cashier can simply press the “total” key or, as in a kiosk example, the customer could proceed to the “checkout” button. In the case where a voucher or coupon is prepaid, and if the customer is only redeeming the voucher and orders nothing else, there could be a zero total due, unless the customer is redeeming the voucher in a different store with higher or lower taxes or differing prices, which differences may or may not be considered when computing any amounts due or owing.
9. Accounting: Coupons, e.g., vouchers, may be accounted for using any applicable means available, including, for example, treating these offers as deferred sales, in which cases, a voucher may be recorded as a liability. When the voucher is purchased, cash may be debited (for the full amount including taxes) and deferred sales would be credited (for the full amount less taxes) and tax liability credited for an amount equal to the value of the taxes. When the voucher is redeemed, the menu item is added to the order, deferred sales would be debited and sales would be credited. Taxes were already collected and accounted for in a previous transaction. To address these issues, the accounting systems, including the POS, for example, could be modified to handle the vouchers in this fashion: When the voucher is purchased, the full amount could be credited to a deferred sales/liability account.
10. If the coupon has a valid GUID, but it has already been redeemed, then the suggestive selling or marketing system could display a new message (to the customer) for example: “Sorry this coupon has already been redeemed, please see the manager” (if the coupon file indicates it has already been redeemed, or it could say: “Sorry this is not a valid coupon.” if the GUID cannot be found.

In one embodiment, new reports and modified reports are used be included to track and report on:
1. Coupon accept rates, average deal value, discount amounts, discount averages, Gross Margin, Offer Frequency, etc.
2. Coupon redemption rates, average days to redemption, average check and average item counts with and without coupons. Gross margin, average check, average item counts for orders with and without accepts or coupons.
3. Estimated or calculated “breakage” i.e., after a user specified “assumed perished date” or “expiration date”—e.g., 90 days from issuance. Breakage is defined as coupons that are issued but are never redeemed.
4. Fraud measurement—i.e., frequency of failed validation attempts (indicating attempts to revalidate a previously redeemed coupon or possible photocopied or forged coupons. Such fraud may include attempts at gaming or fishing the system.

In another embodiment, in addition or in the alternate, a non-integrated system for coupon validation may be provided, which system might include the following key design points, including, for example, without the requirement of any (or limited) changes to the existing POS interface, or any further efforts by the POS software company: allow customers to easily purchase and redeem coupons, while ensuring that coupons are not falsified; permit flexibility in the coupon validation system, i.e., permit in store, multiple store, and chain-wide validation options; and provide for proper accounting of the entire transaction, from coupon issuance and redemption to inventory control.

The following discussion provides further detail regarding a present invention system or method. One goal of the present invention is to convert otherwise disinterested customers into interested customers. For example, customers (end users of the EUD) receive an offer, for example, offer 308, for immediate purchase and acquisition of an item or service, and customers receive an offer, for example, offer 310, to purchase the item, good or service now or at some future date. In the event a customer accepts an offer for a future use or purchase, such customer may receive a coupon good for such item, good or service. For example, in a quick service restaurant (QSR), location, a customer may place an order for a Big Mac, Large Fry and Large Coke, offer 308 could include a dessert item. In addition, offer 310 could include an offer to buy a dessert for later consumption, e.g., next week. A customer can accept such an offer for later consumption via any applicable means, including, for example, by accepting a coupon, which coupon may or may not restrict use of such coupon until a designated later date. In one embodiment, such a coupon may be valid for use immediately or at some other prescribed future date. In another embodiment, the coupon includes a discount. Such discount, if any, may be for more or less or the same discount as offered with offer 308.

In a first embodiment, coupons are valid for specified time periods or time intervals, for example, for certain days, dates, days of the week, months, hours of the day, or any combination of these. In a second embodiment, the coupons include other limiting language or terms, e.g., such a coupon may or may not have an expiration date, or the discount may expire, all at once or over a given period of time. In a third embodiment, the coupons include a bar code or other identification means so that the coupon may be verified as being valid, accurate, not expired, not previously used or redeemed or any other terms and conditions, such as time of day, day of week or other possible restrictions or permissions.

In one embodiment, coupon offers may be for the same or similar item(s) as in offer 308. For example, if a customer orders a Combo Meal Number One and offer 308 includes a dessert item, e.g., an apple pie for $0.50 off, offer 310 could be for the apple pie with the same discount or may offer a coupon for a milkshake for $0.50 or, e.g., $0.70 off. By making such offers for later consumption, Applicants have determined that a greater percentage of customers accept such offers. When presented with a choice of offers 308 and 310 (“now” or “later” offers), the probability that an end user of the EUD may accept one or the other offer increases substantially. This is particularly true for those offers that include a discount component or for those end users that are not very hungry at the time, but think it is likely they will return at some future date. In another embodiment, when an end user accepts offer 310, a present invention system or method requires immediate payment to receive a coupon. When a customer pays for a coupon, they are generally more likely to return or redeem such coupon than if they receive the coupon without payment.

In one embodiment, an end user can choose to accept offer 310 and receive a coupon valid for a subsequent date or purchase, but pay for such coupon at a later time, either when it is convenient or when making such subsequent purchase. In this case, the decision to accept the coupon is easier as little or no cost to the customer is involved. This may increase the likelihood that the customer will accept the coupon.

In one embodiment, a present invention system or method makes use of both types of coupon offers, i.e., paid and promise to pay coupons. In such cases, a present invention system or method could be configured using a table based or rules based system to determine when or if and which type of such offers to make and their payment types. In addition or in the alternate, the system could include a neural net or genetic algorithm to permit the system to optimize the results of such various coupon offer types.

In one embodiment, once offer 308 has been determined, offer 310 for the same or similar item may be presented or another unique item or items may be presented, which items may or may not have anything to do with items or services in offer 308 or other offers 310. Such offers 310 may also be determined without regard to items or services in offer 308 or may use a separate method to determine the best or optimal item(s) to offer.

In another embodiment, information or knowledge about a customer or group of customers or class of customers may be used in making offer 308 or offer 310. For example, a present invention system or method can obtain data regarding an end user's purchasing history and can generate offer 308 or offer 310 accordingly. For example, offer 308 or offer 310 can include a discount on items that an end user never or rarely orders, or only for items the end user rarely or never orders given what is included in order 302. In a further embodiment, a present invention system or method accesses information from existing systems, including, for example, existing POS databases. The information can include customer transaction data, price lists, inventory information or other in or above store, e.g., location data, including, but not limited to data in a POS, back office system, inventory system, revenue management system, loyalty or marketing program databases, labor management or scheduling systems, time clock data, production or other management systems, e.g., kitchen production or manufacturing systems, advertising creation or tracking databases, including click through data, impressions information, results data, corporate or store or location financial information, including, for example, profit and loss information, inventory data, performance metrics, e.g., speed of service data, customer survey information, digital signage information or data, or any other available information or data, or system settings data.

In yet another embodiment, a present invention system or method accesses and uses information known about a customer, a customer's buying habits, current order contents, payment method, destination, e.g., drive through vs. front counter orders vs. pick up orders vs. delivery, etc., total check amount, missing category of items, prior offer acceptance/rejection information, gaming or fishing information, in general or specifically known about a given customer or class of customers, or any other available information. When using such information, a present invention system or method, using rules, or a neural net or genetic algorithm, can better generate offer 308 or offer 310 and determine items, service, or incentives to include or whether or not to include a coupon offer for now or later use or if such coupon should or should not include a discount or other promotional content.

In a still further embodiment, the preceding information can be used to determine or affect, in whole or in part, the marketing message that is presented to such a customer in offer 308 or offer 310. For example, after trying various offers, a present invention system or method may determine that a given customer, or group or class of customers are more likely to accept a discounted coupon when the discount percentage is displayed or presented. Then, a present invention system or method can include such discount percentage amount more often or always, or so long as accept rates by such customer or class of customers remains constant or improves. In another example, a present invention system or method may determine that certain customers are better influenced if the dollar amount of the savings is display, e.g., instead of 50% off, the system might indicate a savings of $0.75. In this fashion, such a learning system could improve the results of the present invention by modifying the type and frequency of offers, and the discount applied, if any, and the method of conveying the offer, including, for example, the amount or type of discount.

In yet a further embodiment, offer 308 or offer 310 can be modified or tested using a present invention system or method, which could improve results over time. For example, the system could be set up with a variety of offer rules, discounts, or offer types, the system could further test such rules, discounts and offers to determine which are most effective and yield maximum sales or profits under any of several conditions.

In one embodiment, coupons are inscribed with one or more identification codes, for example a bar code. Such bar code may include any one or more of the following information or may be a record locator or other serial number or ID number to permit retrieval or verification or use of any one or more of: a) coupon type, e.g., discount, paid or free coupon, b) amount of coupon, c) discount type or amount, d) customer number or other identification, e) location issued number, f) date issued, g) expiration date, h) valid days, dates, hours, etc., i) issued on, j) issued by, or k) any other restrictions or terms, e.g., buy one get one free, or buy one get one half off, or buy a combo meal, get a free French fry, etc., or any combination of the foregoing. Such code, e.g., bar code, may only be a number used to look up any or all of the preceding information or to retrieve any other information available.

Methods to create and affix a bar code to an item are well known in the prior art and any applicable means may be used to create or access such bar code or other coded information. For example, such bar codes could be generated using a stand alone system or an integrated system. An integrated system could include several key design points or objectives including, for example: an option that allows customers to easily purchase and redeem POS terminal or other system's generated coupons, while ensuring that coupons are not falsified. Flexibility in the coupon validation system, i.e., permit in store or location, multiple store or locations, and chain-wide validation options. The system can provide for proper accounting of the entire transaction, from coupon issuance and redemption to inventory control. The system can maximize accounting controls, ensure proper coupon validation (which is a potential shortcoming of any standalone design), speed of service and ease of use.

In another embodiment, end users can identify themselves using overt actions, e.g., by swiping a card, in other embodiments, in addition or in the alternative to providing such identification means overtly, such end users may identify themselves passively.

Key design points of an integrated system include, for example, the following capabilities or components:
1. Modify a current POS interface as little as possible with the goal of shifting as much work away from the POS software company and on to a third party provider.
2. Coupon Printing System
3. Coupon Validation Method
4. Anti-fraud Features
5. Local or above store validation system (option)
6. Marketing system or coupon system controlled databases
7. New reports to provide issuance and redemption analysis
8. Accounting controls and options

The following is a listing of exemplary hardware and software that can be used in a present invention method or system. It should be understood that a present invention method or system is not limited to any or all of the hardware or software shown and that other hardware and software are included in the spirit and scope of the claimed invention.

Store Server (for example, for location 132 and computer 114): Suggestive Selling/Offer Generation Program

The following is a listing of exemplary data bases that can be used in a present invention method or system. It should be understood that a present invention method or system is not limited to any or all of the databases shown and that other databases are included in the spirit and scope of the claimed invention.

Customer Database Customer ID; Customer Transaction History; and Personal Information.

Inventory Database Item ID; Descriptor; QTY; and Price.

Transaction Database Transaction ID; Items 1-n; Offer ID 1-n; Offer Accepted; Accepted Offer Type; and Coupon ID 1-n.

Offer Database Offer ID; Item ID 1-n; and Offer Rules 1-n

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for generating a real time offer or a deferred offer, comprising the steps of:
receiving, using an interface element in at least one specially programmed general-purpose computer, an order from an end user device (EUD), the order including a first item or service available from a first business entity;
generating, prior to fulfillment of the order by the first business entity and using a processor in the at least one specially programmed general-purpose computer and at least one of a first set of rules or a first artificial intelligence program stored in a memory unit for the at least one specially programmed general-purpose computer, a first offer fulfillable as part of the order;
generating, prior to fulfillment of the order by the first business entity and using the processor and at least one of a second set of rules or a second artificial intelligence program stored in the memory unit, a second offer fulfillable after fulfillment of the order by the first business entity; and,
transmitting, using the interface element, the first and second offers to the EUD.

2. The method of claim 1 wherein the first and second sets of rules are the same or the first and second artificial intelligence programs are the same.

3. The method of claim 1 wherein the first and second offers are the same.

4. The method of claim 1 wherein the first and second offers include second and third items or services, respectively and wherein the second and third items or services are the same or wherein the second and third items or services are different.

5. The method of claim 1 wherein the first and second offers include first and second incentives, respectively and wherein the first and second incentives are the same or wherein the first and second incentives are different.

6. The method of claim 1 further comprising the step of determining, using the processor and at least one of a third set of rules or a third artificial intelligence program stored in the memory unit, whether to transmit the second offer before or after receipt of payment for the second offer.

7. The method of claim 1 wherein the EUD is a wireless communications device (WCD) and the method further comprising the steps of:
storing at least one third rule in a memory element for the WCD; and,
executing, using a processor in the WCD, the first or second offer according to the at least one third rule.

8. The method of claim 1 further comprising the steps of:
receiving, using the interface element, at least one third rule from a WCD, or from a general-purpose computer associated with a second business entity;
storing the at least one third rule in the memory element; and,
modifying the first or second offer using the processor and the at least one third rule.

9. The method of claim 8 wherein the first and second business entities are the same.

10. A system for generating a real time offer or a deferred offer, comprising:
an interface element, for at least one specially programmed general-purpose computer, arranged to receive an order from an end user device (EUD), the order including a first item or service available from a first business entity; and,
an offer element, in a processor for the at least one specially programmed general-purpose computer, arranged to:
generate, prior to fulfillment of the order by the first business entity and using at least one of a first set of rules or a first artificial intelligence program stored in a memory unit for the at least one specially programmed general-purpose computer, a first offer fulfillable as part of the order; and,
generate, prior to fulfillment of the order by the first business entity and using the processor and at least one of a second set of rules or a second artificial intelligence program stored in the memory unit, a second offer fulfillable after fulfillment of the order by the first business entity; and,
transmit, using the interface element, the first and second offers to the EUD.

11. The system of claim 10 wherein the first and second sets of rules are the same or the first and second artificial intelligence programs are the same.

12. The system of claim 10 wherein the first and second offers are the same.

13. The system of claim 10 wherein the first and second offers include second and third items or services, respectively and wherein the second and third items or services are the same or wherein the second and third items or services are different.

14. The system of claim 10 wherein the first and second offers include first and second incentives, respectively and wherein the first and second incentives are the same or wherein the first and second incentives are different.

15. The system of claim 10 wherein the offer element is arranged to determine, using at least one of a third set of rules or a third artificial intelligence program stored in the memory unit, whether to transmit the second offer before or after receipt of payment for the second offer.

16. The system of claim 10 wherein the EUD is a wireless communications device (WCD) storing at least one third rule in a memory element for the WCD and arranged to execute, using a processor in the WCD, the first or second offer according to the at least one third rule.

17. The system of claim 10 wherein the interface element is arranged to receive at least one third rule from a WCD, or from a general-purpose computer associated with a second business entity and wherein the offer element is arranged to:
store the at least one third rule in the memory element; and,
modify the first or second offer using the processor and the at least one third rule.

18. The system of claim 17 wherein the first and second business entities are the same.

19. A method for generating a real time offer or a deferred offer, comprising the steps of:
receiving, using an interface element in at least one specially programmed general-purpose computer, an order from an end user device (EUD), the order including a first item or service available from a first business entity;
generating, prior to fulfillment of the order by the first business entity and using a processor in the at least one specially programmed general-purpose computer and at least one of a first set of rules or a first artificial intelligence program stored in a memory unit for the at least one specially programmed general-purpose computer, a first offer fulfillable as part of the order; or,
generating, prior to fulfillment of the order by the first business entity and using the processor and at least one of a second set of rules or a second artificial intelligence program stored in the memory unit, a second offer fulfillable after fulfillment of the order by the first business entity; and,
transmitting, using the interface element, the first or second offer to the EUD.

20. The method of claim 19 further comprising the step of determining, using the processor and at least one of a third set of rules or a third artificial intelligence program stored in the memory unit, which of the first or second offers to generate and transmit.

21. The method of claim 20 wherein one or more of the first, second, or third sets of rules are the same or wherein one or more of the first, second, or third artificial intelligence programs are the same.

22. A system for generating a real time offer or a deferred offer, comprising:
an interface element, for at least one specially programmed general-purpose computer, arranged to receive an order from an end user device (EUD), the order including a first item or service available from a first business entity; and,
an offer element, in a processor for the at least one specially programmed general-purpose computer, arranged to:
generate, prior to fulfillment of the order by the first business entity and using at least one of a first set of rules or a first artificial intelligence program stored in a memory unit for the at least one specially programmed general-purpose computer, a first offer fulfillable as part of the order; or,
generate, prior to fulfillment of the order by the first business entity and using the processor and at least one of a second set of rules or a second artificial intelligence program stored in the memory unit, a second offer fulfillable after fulfillment of the order by the first business entity; and,
transmit, using the interface element, the first or second offer to the EUD.

23. The system of claim 22 wherein the offer element is arranged to determine, using at least one of a third set of rules or a third artificial intelligence program stored in the memory unit, which of the first or second offers to generate and transmit.

24. The system of claim 23 wherein one or more of the first, second, or third sets of rules are the same or wherein one or more of the first, second, or third artificial intelligence programs are the same.
